(19) United States
(12) Patent Application Publication
(10) Pub. No.: US 2017/0374398 A1
(43) Pub. Date: Dec. 28, 2017

(54) COMPUTING INFRASTRUCTURE FOR MOVIE MAKING AND PRODUCT PLACEMENTS

(71) Applicants: BINDU RAMA RAO, LAGUNA NIGUEL, CA (US); GLENN T. HAMASAKI, JR., SAN CLEMENTE, CA (US)

(72) Inventors: BINDU RAMA RAO, LAGUNA NIGUEL, CA (US); GLENN T. HAMASAKI, JR., SAN CLEMENTE, CA (US)

(21) Appl. No.: 15/191,472

(22) Filed: Jun. 23, 2016

(51) Int. Cl. H04N 21/234; H04N 21/81; H04N 21/472; H04N 21/2668; H04N 21/262; H04N 21/854; H04N 21/2547

(52) U.S. Cl. CPC H04N 21/23424; H04N 21/854; H04N 21/812; H04N 21/2547; H04N 21/2668; H04N 21/262; H04N 21/47202

(57) ABSTRACT

A computing infrastructure for movie making. It provides movie creation and post-production services. Product placement services are provided for digital media of all kinds such as movies, video clips, audio clips, etc. The processing starts when a new digital media is created/uploaded by a user. Then detection of placeholder objects (one or more) is facilitated. The output is a catalog of placeholder objects. The user can review this output and modify it, and store it for subsequent processing. Then the user can replace placeholder objects with product placement material to create a modified digital media that is distributed.

### CROSS REFERENCES TO RELATED APPLICATIONS

### BACKGROUND

### 1. Technical Field

The present invention relates generally to movie making and specifically to product placements in movies.

### 2. Related Art

Several types of movies are being made where manufacturers of products are accommodated, and products are strategically placed in the movies made. For example, products placed such as Apple computers are prominently placed in different scenes in a movie. Product placements typically take the form of a product manufacturer funding the movie makers at least partially to ensure that their products get prominence in the movie or as part of a story. This requires the movie makers to spend time and energy to recruit product manufacturers and spend significant time and energy in acquiring funds from them. Some product manufacturers are not satisfied in how their products are featured in the completed movie and complain about the wasted money and efforts.

One of the objects of the present invention is the making of product placements easy and efficient. Another of the objects of the present invention is the need to make product placements possible in video clips made by non-professionals and individuals. There is just no way non-professional movie makers or individuals making small video clips can effectively make product placements or even think about getting product manufacturers involved in their movie making.

To solve some of these problems and offload some of these responsibilities, product manufacturers have begun to make/produce movies themselves. For example, Lego corporation makes Lego based movies and distributes them. However such attempts are few and far between and product manufacturers really don't want to be movie makers, they would rather focus on getting out a better product.

Further limitations and disadvantages of conventional and traditional approaches will become apparent to one of ordinary skill in the art through comparison of such systems with the present invention.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1A is a perspective block diagram of a network comprising a computing infrastructure for digital media such as movies comprising a placeholder identification manager that determines placeholder objects, and a automatic replacement manager that selectively replaces some of those placeholder objects identified, wherein the replacements made are driven by product placement needs of product manufacturers and product promoters;

FIG. 1B is a perspective block diagram of a network comprising a computing infrastructure having a plurality of computing nodes each of the plurality of computing nodes comprising a processor, memory and storage;

FIG. 2 is a perspective block diagram of another network comprising a digital media processing server that processes an uploaded digital media to identify placeholder objects that can be replaced by product placements, and a product placement & distribution server that takes the identified placeholder objects and replaces one or more of these placeholder objects with product placement material to create a modified digital media that is then distributed;

FIG. 3 is a perspective block diagram of a network wherein a mobile device provides digital media creation and product placement services, wherein a modified digital media with product placements are uploaded to a distribution server for eventual distribution to a plurality of online and mobile viewers/subscribers; and

FIG. 4 is an flow chart of an exemplary operation of the computing infrastructure of FIG. 1 in providing product placement services for digital media of all kinds such as movies, video clips, audio clips, etc.

### DETAILED DESCRIPTION OF THE DRAWINGS

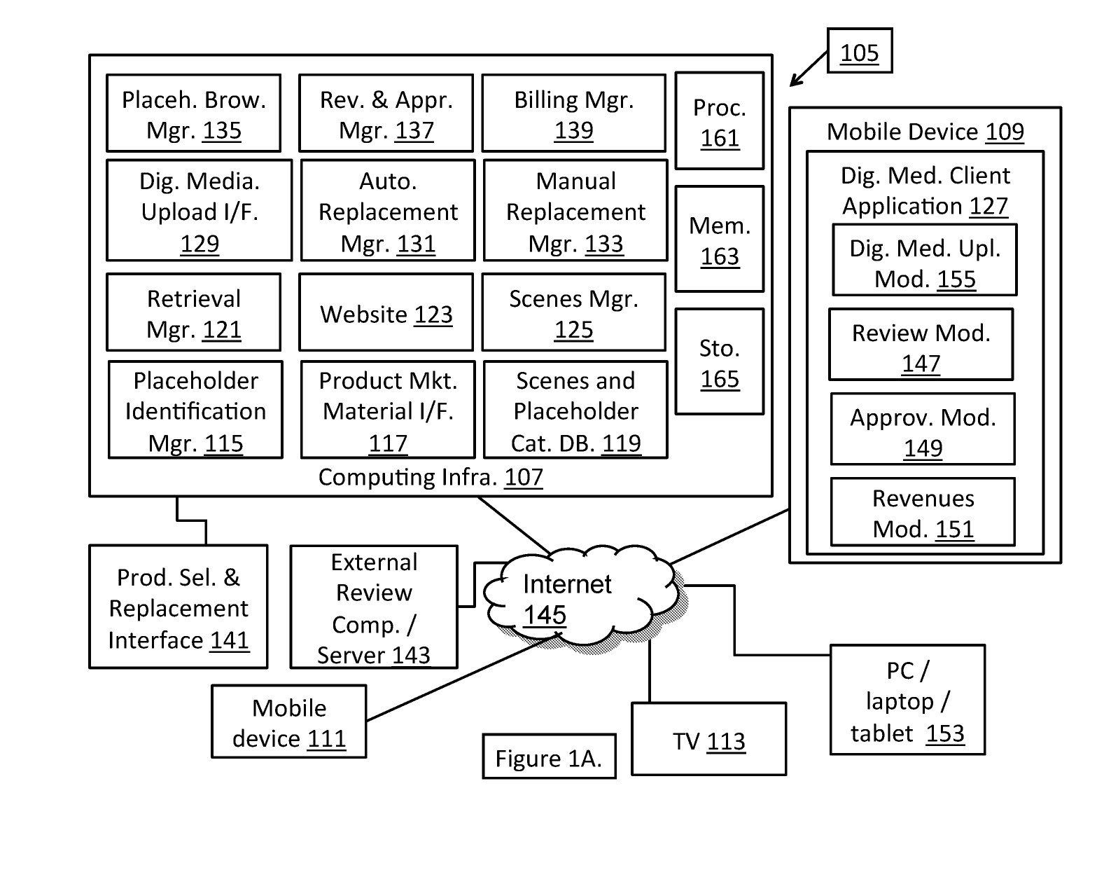

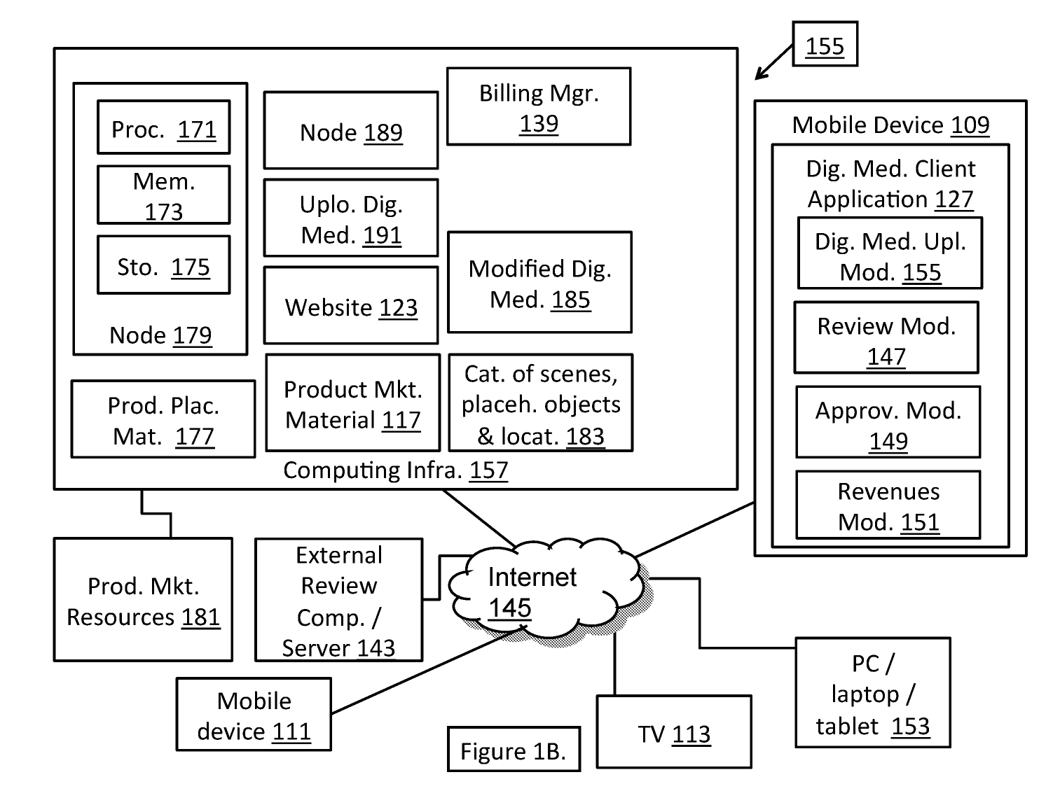

FIG. 1A is a perspective block diagram of a network 105 comprising a computing infrastructure 107 for digital media such as movies comprising a placeholder identification manager 115 that determines placeholder objects, and a automatic replacement manager 131 that selectively replaces some of those placeholder objects identified, wherein the replacements made are driven by product placement needs of product manufacturers and product promoters. The computing infrastructure 107 comprises memory 163, at least one storage 165 configured to store a plurality of processing instructions, and at least one processor 161 in communication with the at least one storage. The at least one processor processor 161 of the computing infrastructure 107 are configured to execute instructions to identify placeholder objects and their corresponding locations in a movie/digital media, and to determine, selectively, appropriate replacements for the placeholder objects among a plurality of product placement material (uploaded by product manufacturers, for example).

The computing infrastructure 107 replace at least one of the extracted placeholder objects with at least one of the appropriate replacements using the corresponding locations and output a modified digital media. For example, one of the extracted placeholder objects in a movie is a bottle of red wine, and the replacement for that provided by a winemaker in Napa is a Robert Mondavi Cabernat Sauvignon bottle, which the computing infrastructure 107 uses to swap the placeholder object (bottle of red wine) out. Based on configuration or user preference, such swapping can be at a first place of occurrence of the placeholder object in question, at a first few places (such as the first 5 places/locations in the movie where it is encountered), throughout the movie, or in specific scenes in the movie.

The computing infrastructure 107 also distributes the modified digital media created by selective replacements of one or more placeholder objects encountered in the movie created. Such replacements are post-production of a movie, and before its release in one embodiment, during movie production in another embodiment, after individual scenes are completed but the movie is only partially completed, and after release of the movie in another related embodiment.

Based on user activation and configuration, a manual replacement manager 133 is launched to enable manual specification of product replacements. For example, at specific locations in the movie that is flagged by the placeholder identification manager 115, and saved in the scenes and placeholder catalog database 119, a user swaps out or replaces the placeholder objects (one or more) with replacements selected from a collection of product placement objects available. Product marketing material uploaded by manufacturers and promoters are received via a product marketing material interface 117. Such product marketing material (also referred to as the one of the plurality of product placement material) are stored in a database or in storage 165, and used as necessary to replace placeholder objects that are manually or automatically identified in the movie.

An auto replacement manager 131 facilitates automated replacement of one or more placeholder objects, by appropriate ones of the one of the plurality of product placement material available, based on configuration, or based on availability of specific product placement material. The replacements can be conducted is specific scenes of a movie, in specific locations in a movie, or throughout the movie, based on replacement configuration setup.

The placeholder objects encountered and cataloged for a movie manually or as an automated activity by the placeholder identification manager 115, are subsequently browsed and managed by a user using a placeholder browser manager 135. A manual replacement manager 133 (an application, for example, with movie screen browsing facility, individual frame display facility, next and previous frame navigation facility, etc.) facilitates manual replacement of one or more placeholder objects, by appropriate ones of the one of the plurality of product placement material available, based on user selections and preferences. For example, the user may select a scene N in a movie, locate the first placeholder object which happens to be a wine bottle, then pull up a list of product placement material (or pull up by product category, if necessary), select a Robert Mondavi Red Wine object (image in 2D or 3D form, as necessary, in raster graphics or vector graphics, as necessary) and drag and drop it over the placeholder object which is flagged. More specifically, for example, using the manual replacement manager 133, the user retrieves scene N from the movie, stops at a frame F (such as 100) where the first placeholder object is encountered/located, pulls up a list of product placement material, selects one of the entries as the replacement, and drops it onto the frame F and verifies that the replacement has successfully been conducted. Then selecting the Next button provided by the manual replacement manager 133, the frame/scene at a location of the next placeholder object encountered is displayed, for the next selective manual replacement, with accompanying recommendations for possible replacements at that placeholder object provided by the manual replacement manager 133. Thus a user can view what product placement material are being recommended for each placeholder object, at each of such placeholder object locations, and even choose to ignore the recommendations in making the modified movie with replacements. The modified movie thus created is reviewed as necessary by a user, using a review & approval manager 137. The user can reject some of the replacements made, all of the replacements made, etc. The product placement material assembled by a user to be used in replacements of placeholder objects are organized by category, by popularity, by importance, by size, etc. Replacements made are verified by a user using the review & approval manager 137. It is therefore possible to manually replace specific instances of the placeholder objects, as selected by the user, employing specific ones of the product marketing materials (such as images of products manufactured or promoted by an organization) or subsets thereof provided by the product manufacturers, and review them before approval or rejection.

The computing infrastructure 107 is further configured to execute instructions to broadcast the modified digital media based on a schedule, using a website 123 for example, and to additionally distribute modified digital media on demand. The digital media is a movie and the modified digital media is a movie comprising at least one of the plurality of product placement material, in one configuration. The digital media is a video clip uploaded to the digital media upload interface 129 in another configuration. The digital media is an audio clip uploaded to the digital media upload interface 129 in yet another configuration.

The computing infrastructure 107 identifies placeholder objects. For example, it determines scenes in the digital media, and processes each scene determined to extract a catalog of placeholder objects with corresponding locations of those placeholder objects in that scene. It saves the catalog of placeholder objects for each scene in the scenes and placeholder catalog database 119, from which they are retrieved as necessary for selective placeholder object replacements, manually or in automated mode.

In one configuration of the computing infrastructure, the processor 161 provides instruction to replace at least one of the extracted placeholder objects (stored, for example, in the scenes and placeholder catalog database 119) which also include instructions to:
a. compare, for each scene, the catalog of placeholder objects (identified previously by the placeholder identification manager 115 or provided by a user as inputs along with the digital media) with the plurality of product placement material (provided by product manufacturers, their promoters, or by marketing companies, for example), or a subset thereof, and identify the at least one of the appropriate replacements that will be used to create a modified digital media; and
b. swap, in each scene, the at least one of the extracted placeholder objects in that scene with corresponding ones of the at least one of the appropriate replacements for that scene identified by the comparing (the activity described above).

The user who provides/uploads a digital media (video clip, movie, audio clip, animations, 3D maps, 3D streaming inputs, etc.) optionally provides a catalog of placeholder objects, which is enhanced, based on configuration and user expressed need, by further identification of additional placeholder objects by the placeholder identification manager 115. The user provided catalog of placeholder objects is stored in the scenes and placeholder catalog database 119 from where it is retrieved by a user for placeholder object review employing the placeholder browser manager 135, or retrieved for auto replacement of placeholder objects by the auto replacement manager 131, etc.

In one embodiment, the user who provides/uploads a digital media (video clip, movie, audio clip, animations, 3D maps, 3D streaming inputs, etc.) also provides a catalog of placeholder objects, and the computing infrastructure 107 conducts auto replacement of user specified placeholder objects without any additional placeholder object identification using the placeholder identification manager 115. In this scenario, the computing infrastructure 107 triggers product placements by the auto replacement manager 131 and the creation of a modified digital media for sharing and distribution. In a related embodiment, the user not only provides a catalog of placeholder objects along with the digital media, but also provides corresponding list of product marketing material (such as images for replacement, clips for replacements, etc.) which is then used by the auto replacement manager 131 to create the modified digital media (after swapping the product marketing material or a subset thereof with the corresponding placeholder objects identified by the user that is provided as inputs).

The computing infrastructure 107 manages/facilitates product placements (by identification of placeholder objects, their replacements, etc.) in digital media such as a video clip and creates a modified digital media that is a video clip comprising at least one of the plurality of product placement material (which, for example, may be provided by the user, provided by a product manufacturer or promoter, or provided by the creator of the digital media, etc.)

The computing infrastructure 107 also conducts product placements in digital media when the digital media is an audio clip, and the modified digital media thereby created is an audio clip comprising at least one of the plurality of audio product placement material.

The computing infrastructure 107 provides a product selection and replacement interface 141 that a user, using a remote PC/laptop/tablet 153 for example, can use to select particular product placement material currently available and assign them to be replacements to particular placeholders identified in a specified (uploaded) digital media. Thus, a user can remotely browse available plurality of product placement material using the remote PC/laptop/tablet 153, and select those that the user finds interesting or profitable to use as replacements in specific ones of the placeholder objects located/identified in the uploaded digital media. The created modified digital media is then distributed by the user after download to an external server, such as the external review computer/server 143, etc.

A TV 113 is used to view/rendered modified digital media by a user. It is also used to review modified digital media before approval for distribution, used to browse all available placeholder objects identified, etc.

A mobile device 109 is used to upload video clips, audio clips, etc. It comprises a digital media client application 127 that facilitates upload of digital media, review of modified digital media, approval and reviews of revenues generated by distributing the modified digital media comprising product placements. The digital media client application 127 is used to review modified digital media created for selective approval using, using a review module 155 of the digital media client application 127. It is used to approve the replacement of placeholder objects (identified by the user or automatically identified) by product placements (using marketing material for replacements provided by the user or otherwise). It is also used to check on revenues generated from product placements, by different versions of the same digital media, each version, for example, employing a different set of product placements (based on geographical regions, target demographics, etc.). Thus, different versions of the modified digital media is created and distributed by the computing infrastructure 107 for various marketing, legal, regulatory or technical reasons, which includes demographic variations, age variations of target audience, seasons, geographical regions, etc.

FIG. 1B is a perspective block diagram of a network 155 comprising a computing infrastructure 157 having a plurality of computing nodes 179, 189, each of the plurality of computing nodes 179, 189 comprising a processor 171, memory 173 and storage 175. The computing infrastructure 157 also comprises at least one storage 175 configured to store a plurality of processing instructions, and at least one processor 171 in communication with the at least one storage 175, and configured to execute instructions to upload a plurality of product placement material 177 provided by a plurality of product marketing sources 181. The computing infrastructure 157 uses processor 171 of the computing node 179, for example, to identify and catalog placeholder objects and their corresponding locations in a digital media 191 (a movie uploaded by a user, for example, referred to as the uploaded digital media 191), which are then saved in a catalog of scenes, placeholder objects and locations 183. The computing infrastructure 157 then uses processor 171 of the computing node 179 to replace at least one of the identified placeholder objects with at least one of the plurality of product placement material 177, using the corresponding locations and outputs a modified digital media 185. It then conducts billing transactions to charge at least one organization (among the product marketing resources 181, for example) for the replacement of the at least one of the identified placeholder objects in the digital media 191 uploaded for processing.

In one configuration, the at least one processor 171 is further configured to execute instructions to determine a plurality of scenes in the digital media 191. The process 171 is configured to identify and catalog scene specific placeholder objects for selective replacement in the plurality of scenes (wherein, for example, the replacements are located in the product placement material 177 provided by manufacturers and product promoters, etc.) and also configured to promote replacement of the scene specific placeholder objects.

In one configuration, the at least one processor 171 of the computing infrastructure 157 is further configured to execute instructions to determine automatically, appropriate replacements for the placeholder objects for the digital media 191 among a plurality of product marketing material 177.

In one configuration, the at least one processor 171 of the computing infrastructure 157 creates the modified digital media 185 by replacement of the at least one of the identified placeholder objects in the digital media 191, which is then distributed to a plurality of client devices, such as the TV 113, a mobile device 111, the mobile device 109, the PC/Laptop/tablet 153, etc.

Digital media 191 is uploaded to create the modified digital media 185 by a user, or by an external server, and the computing infrastructure 157, by selective replacement of identified placeholder objects with one or more of the plurality of product placement material 177, generated the modified digital media for subsequent distribution/sharing.

In one configuration of the computing infrastructure, the processor 171 of the computing node 179 provides instruction to replace at least one of the identified placeholder objects in the uploaded digital media 191 with at least one of the plurality of product placement material 177, wherein the instruction also includes instruction to:
a. scale the at least one of the plurality of product placement material 177 as necessary;
b. enhance the lighting of the at least one of the plurality of product placement material 177 as necessary; and
c. swap the at least one of the plurality of product placement material 177 as necessary with the at least one of the identified placeholder objects (detected or identified in the uploaded digital media 191).

Most of the components of the network 155 of FIG. 1B that have reference numbers similar to those in FIG. 1A have similar functionality and behavior.

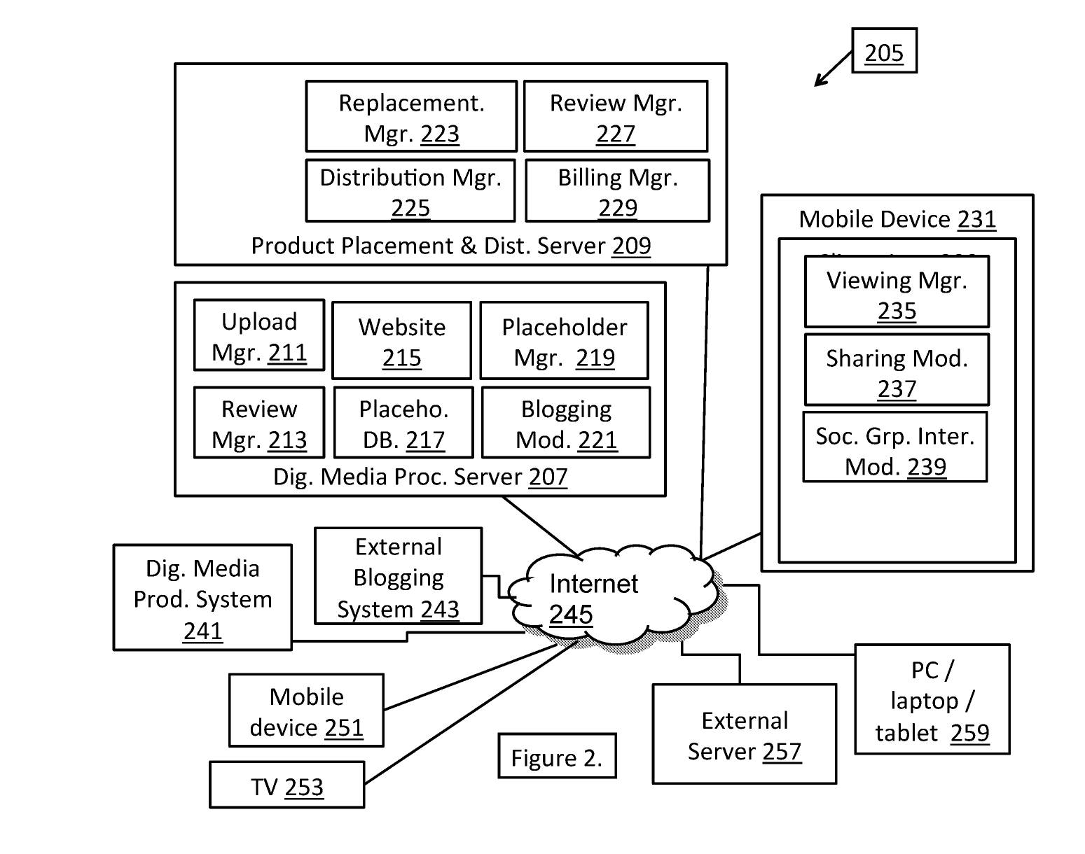

FIG. 2 is a perspective block diagram of another network 205 comprising a digital media processing server 207 that processes an uploaded digital media to identify placeholder objects that can be replaced by product placements, and a product placement & distribution server 209 that takes the identified placeholder objects and replaces one or more of these placeholder objects with product placement material to create a modified digital media that is then distributed. The digital media processing server 207 comprises an upload manager 211 for uploading digital media for incorporating product placements (through inclusion or replacement of placeholder objects identified), and a placeholder manager 219 that process the uploaded digital media to determine placeholder objects (and corresponding locations in the digital media), which it then stores in a placeholder object database 217. In one configuration, the placeholder object database 217 is accessible by the product placement & distribution server 209 via Internet 245. The upload manager 211 also facilitates upload of information on placeholder objects for uploaded digital media. For example, the maker of a movie or a video clip catalogs all the placeholder objects employed in the making of the movie or video clip, and collects that information and communicates it to the digital media processing server 207. This catalog is enhanced further by processing the uploaded digital media for additional placeholder objects (by the placeholder manager 219).

The product placement & distribution server 209 comprises a replacement manager 223 that replaces placeholder objects in the digital media (which it accesses over Internet from the digital media processing server 207 as necessary) employing data stored in the placeholder object database 217, such as placeholder objects and their corresponding locations in the digital media. The replacement manager 223 eventually after processing the digital media creates the modified digital media which it distributes/shares employing a distribution manager 225. The product placement & distribution server 209 comprises also provides a review manager to review the modified digital media before distributing—such review is conducted by a user over

Internet employing a PC/laptop/tablet 259 or mobile device 231, for example. Billing manager 229 facilitates billing one or more product manufacturers or product promoters for product placements in the distributed modified digital media. Billing is based on several factors, for example, billing is based on factors including the number of different products placed, the number of places/locations in the movie where each of the different products are placed (replacing a placeholder object), the duration of display of each product placement instances in the movie, etc.

A digital media production system 241 is used by a user to create movies, video clips, animations, audio clips, etc. that are then uploaded to the digital media processing server 207 in order to identify, on-the-fly, placeholder objects which the user can then replace, if necessary, with product placements to crate some additional revenues while distributing the digital media to fans, subscribers, etc.

A mobile device 231 is used by a user (who could also be the creator of the digital media) to review the modified digital media distributed by the distribution manager 225. The user can share the modified digital media, for example y obtaining a link, reference or an URL to it and sharing it over Facebook, Whatsapp, Snapchat, Twitter, etc. A sharing module 237 facilitates such user-initiated sharing of the modified digital media distributed by the distribution manager 225. Sharing information is tracked by the billing manager 229 for billing purposes, as it is expected to impact revenues from product placement. The user of the mobile device 231 can interact over social groups regarding the modified digital media, employing the social group interaction module 239.

A user using the PC/laptop/tablet 259 can create a digital media, upload it to the digital media processing server 207 using the upload manager 211, have placeholder object identified after processing, then replace placeholder objects (one or more) using the replacement manager 223, and distribute a modified digital media created by replacements of placeholder objects with product marketing material selected by the user of automatically selected by the replacement manager 223. The user then generates revenues on an ongoing basis when the modified digital media is viewed by online or mobile viewers/subscribers, the product manufacturers and promoters being responsible for settling payments due to the user who is the creator or owner of the digital media.

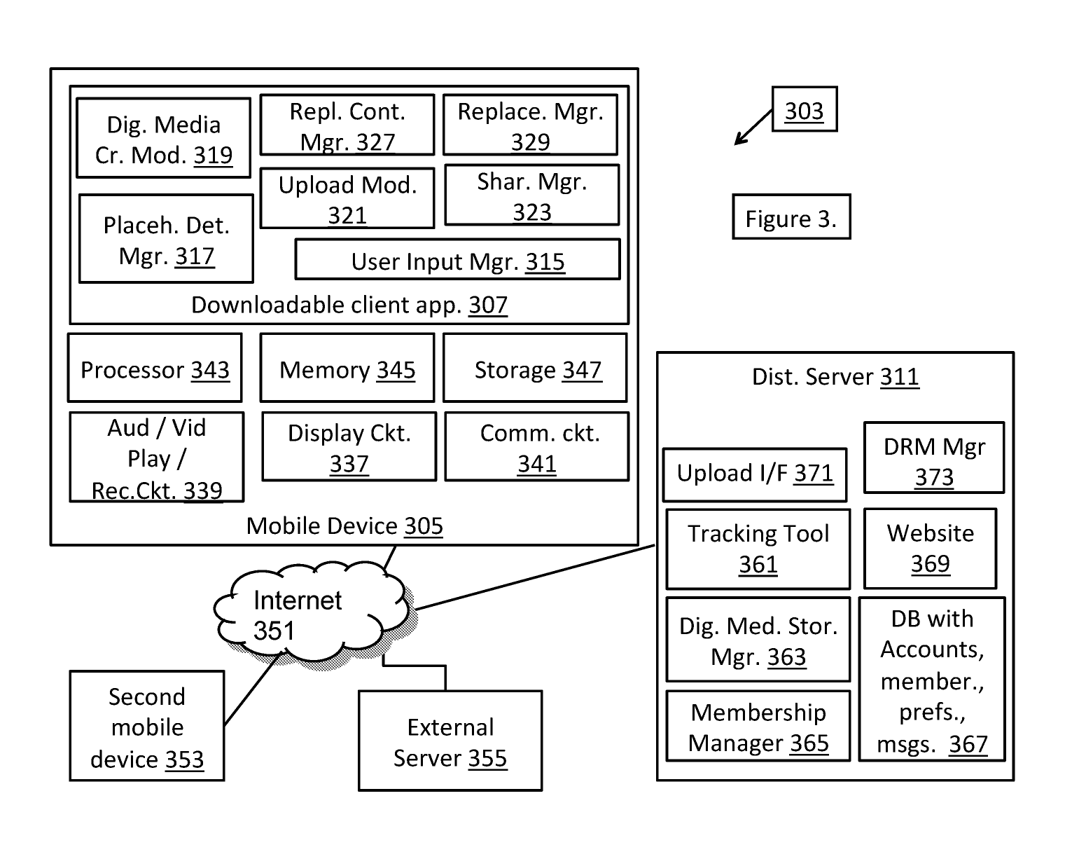

FIG. 3 is a perspective block diagram of a network 303 wherein a mobile device 305 provides digital media creation and product placement services, wherein a modified digital media with product placements are uploaded to a distribution server 311 for eventual distribution to a plurality of online and mobile viewers/subscribers. The mobile device 305 comprises a processor 343, a memory 345, a storage 347, an audio/video play & recording circuitry 339, a display circuitry 337, and a communication circuitry 341. The mobile device 305 comprises a downloadable client app 307 that not only helps create a digital media via a digital media creation module 319, but also facilitates placeholder object detection using the placeholder detection manager 317. The downloadable client app 307 also helps a user receive an uploaded/transferred digital media which the user processes using the placeholder detection manager 317. A replacement manager 329 of the downloadable client app 307 facilitates replacement of placeholder objects using product placement material received from one or more product manufacturers or promoters. A replacement content manager 327 facilitates retrieval of and storage of product placement material from servers of one or more product manufacturers or promoters, such as the external server 355. A user input manager 315 helps a user review and select one or more product placement material for replacements of one or more placeholder objects, at one or more locations in the digital media. A sharing manager 315 helps the user in sharing the modified digital media with friends, with customers, and with online servers, such as the distribution server 311.

The distribution server 311 makes it possible to distribute modified digital media comprising placeholder objects, wherein the placeholder objects are replaced by product placements based on user specification or based on automatic replacement of placeholder objects. It comprises an upload interface 371 to receive modified digital media for distribution, a DRM manager 373 that makes it possible to securely distribute the modified digital content to selected viewers and subscribers who are authorized to view it, a tracking tool 361 to keep track of all those viewers and subscribers who receive the modified digital media. The tracking tool 361 also tracks user response to the products placements, efficacy of the products placements, user interactions with product placement materials incorporated into the digital media—such user interactions, in one related embodiment, are by means of audio commands or requests, user selection using a remote or a mouse, etc.

The distribution server 311 comprises a membership manager 365 that tracks user memberships and authorizations to receive different categories and different genres of modified digital media. It also comprises a database with accounts, membership details, preferences and user messages 367 that is used to manage memberships, preferences, billing details for users, subscription details, various type of accounts for accessing modified digital media by users from multiple client devices, such as second mobile device 353, etc.

The distribution server 311 also comprises a digital media storage manager 363 where modified digital media are stored and where the lifecycle of modified digital media are managed. It supports specification of a start date for distribution, an end date for distribution, desired target audience types, desired target demographics, etc.

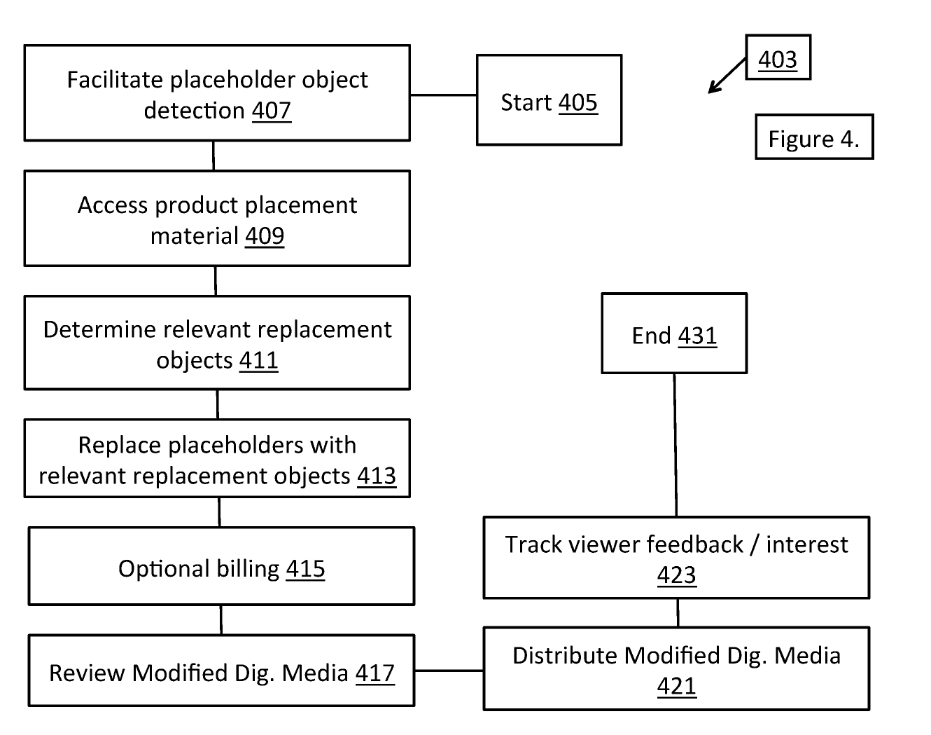

FIG. 4 is an flow chart of an exemplary operation of the computing infrastructure 107 of FIG. 1 in providing product placement services for digital media of all kinds such as movies, video clips, audio clips, etc. At a start block 405, the processing starts when a new digital media is uploaded by a user. Then at a next block 407 detection of placeholder objects (one or more) is facilitated. The output is a catalog of placeholder objects. The user can review this output and modify it, and store it for subsequent processing.

At a next block, available product placement material that can be used replacement objects are accessed. This information may have been provided by one or more product manufacturers or promoters, and is collected and presented to the user for perusal and selection as potential replacement objects.

At a next block 411, determination is made, either automatically, or based on user inputs and selections, of relevant replacement objects. For example, the user selects one or more product placement materials, and specifies which placeholder objects they should replace, and at what locations in the digital media such replacements need to occur.

Then, at a next block 413, placeholder objects are replaced by relevant replacement objects, i.e. by selected ones of the product placement materials (or subset of such material). Then the modified digital media is stored for review and distribution (after approval).

At a next block 415, one or more product manufacturers or promoters are billed for their product placements, based on several different parameters. For example, a manufacturer who has 2 products placed in the movie at 5 different locations in the movie, each for 3 seconds duration is billed a certain amount X, and another manufacturer who has 2 products placed in the movie at 10 different locations in the movie, each for 3 seconds is billed an amount Y, which is likely to be double the amount X, etc. Different billing formulas are employed, as necessary, based on supply of placeholder object locations, and demand for product placements in those locations. Billing also incorporates, in some configuration where (which location) in the movie the specific product location occurs, and what exactly the context in the movie storyline is at those locations. For example, product placements in dramatic moments/scenes of a movie costs more than at other places, and product placements at the beginning cost more than those at the end.

Then, at a next block 417, the modified digital media with product placement related modifications/inclusions/replacements/edits is made available for review by one or more reviewers. Authorized reviewers are allowed to review the modified digital media and to provide comments and or approval. Then, at a next block 421, the modified digital media is distributed to authorized viewers and selected target audience such as subscribers, members of a group, etc. often after approval by a creator, authorized reviewer, etc. At a next block 423, tracking of user interactions with the product placements, user feedback on the modified digital media, user comments, frequency of access of the modified digital media, etc. occurs and data of various kind is collected for analysis. Finally, processing terminates at the end block 431.

Another exemplary method of conducting product placements on digital media, such as movies and video clips, for example during post-production activities for the digital media, comprises tasks performed by a computing device comprising a processor, memory and storage. The exemplary method conducted by the computing device comprises identifying placeholder objects and their corresponding locations in a digital media and storing such information, such as in a database, and then determining selectively appropriate replacements for the placeholder objects among a plurality of product placement material (with user participation or in an automated mode), before finally replacing at least one of the extracted placeholder objects with at least one of the appropriate replacements using the corresponding locations and outputting a modified digital media.

The exemplary method of conducting product placements also includes distributing the modified digital media on demand and broadcasting the modified digital media based on a schedule. The digital media is a movie in some configurations and the modified digital media is a movie comprising at least one of the plurality of product placement material. Identifying placeholder objects, in some configurations involve determining scenes in the digital media and then processing each scene to extract a catalog of placeholder objects with corresponding locations of those placeholder objects in that scene.

In some configurations, replacing at least one of the extracted placeholder objects comprises comparing, for each scene, the catalog of placeholder objects with the plurality of product placement material or a subset thereof, to identify the at least one of the appropriate replacements, and then swapping, in each scene, the at least one of the extracted placeholder objects in that scene with corresponding ones of the at least one of the appropriate replacements for that scene identified by the comparing.

Comparing placeholder objects to product placement material is conducted manually by a user in some configurations, as are the swapping operations that replace the placeholder objects with relevant/useful ones from the product placement material—these manual operations are conducted by a user employing the computing device, wherein the computing device provides display screens to display individual frames of digital media (and other details of the digital media at various granularity, frame rate, colors, background manipulation, etc.) and also solicits user input. The computing device guides a user, via user input screens, user prompts, user instruction sidebars, etc. to select the at least one of the appropriate replacements; and swap, in each scene, the at least one of the extracted placeholder objects with corresponding ones of the at least one of the appropriate replacements for that scene.

In some configurations, the digital media is a video clip and the modified digital media is a video clip comprising at least one of the plurality of product placement material. In some other configurations, the digital media is an audio clip and the modified digital media is an audio clip comprising at least one of the plurality of audio product placement material.

In one embodiment, the computing infrastructure 107 of this disclosure relates to a cloud computing system that comprises a plurality of computing nodes and a virtualization layer configured to create a virtual computing environment on each of the plurality of computing nodes. The infrastructure configures to receive an authorization to service a product placement plan, the product placement plan being from a user and including at least one instance to replace placeholder products identified within a specific movie with products promoted by product manufacturers. In response to the authorization for product placements, the computing infrastructure 107 is used to identify at least one placeholder object that as a target for replacement. In addition, the infrastructure includes the ability to search the plurality of computing nodes based on at least one end user product placement needs and identify at least one computing node having one or more computing resources that can meet those needs. The computing infrastructure 107 launches the auto replacement manager 131 with the proper configuration to effect desired product replacements, employing the assigned/identified at least one computing node. Note that based on configuration, the manual replacement manager 133 is launched to enable manual specification of product replacements, at specific locations in the movie flagged by the placeholder identification manager 115, which can be verified by a user using the placeholder browser manager 135, thereby making it possible to manually replace specific instances of the placeholder objects, as selected by the user, employing specific ones of the product marketing materials or subsets thereof provided by the product manufacturers.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

The term “computer infrastructure” employed in the present invention includes a set of computers within a distributed network in a data center, a set of on-demand computing power provided in a cloud computing environment, and a geographically distributed network of cloud computing resources that collaborate to provide the services described herein, etc.

The term ‘processor’ used in the present invention includes a series of processors within a computer in the computing infrastructure 107, a distributed on-demand processing power accessed in a cloud computing environment, a set of computers that coordinate their processing power usage in a network, a distributed set of computers across the Internet that provide processing power that can be employed to provide a service, etc.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A method performed by a computing device comprising a processor, memory and storage, the method comprising:
identifying, by an automated identification manager in an automated mode, objects and their corresponding locations in a digital media;
swapping and directly replacing in specified scenes of the digital media, using an automated replacement manager, at least one of the identified objects with at least one of the appropriate replacements among a plurality of product placement material in an automated mode, using the corresponding locations and outputting a modified digital media;
distributing by a website server the modified digital media on demand; and
broadcasting the modified digital media based on a schedule;
wherein the automated identification manager and automated replacement manager are collectively part of the computing device;
wherein the computing device swaps and replaces an identified object with an appropriate replacement directly in the given digital media that is distributed right away.

2. The method of claim 1 wherein the digital media is a movie and the modified digital media is a movie comprising at least one of the plurality of product placement material.

3. The method of claim 1 wherein identifying objects comprises:
determining scenes in the digital media;
processing each scene to extract a catalog of identified objects with corresponding locations of those identified objects in that scene.

4. The method of claim 3 wherein swapping and replacing at least one of the identified objects comprises:
comparing, for each scene, the catalog of identified objects with the plurality of product placement material or a subset thereof, to identify the at least one of the appropriate replacements; and
swapping, in each scene, the at least one of the identified objects in that scene with corresponding ones of the at least one of the appropriate replacements for that scene identified by the comparing.

5. The method of claim 4 wherein the comparing and swapping and replacing operations are conducted manually by a user with the computing device soliciting user input, wherein the computing device guides a user to:
select the at least one of the appropriate replacements; and
swap, in each scene, the at least one of the extracted placeholder objects with corresponding ones of the at least one of the appropriate replacements for that scene.

6. The method of claim 1 wherein the digital media is a video clip and the modified digital media is a video clip comprising at least one of the plurality of product placement material.

7. The method of claim 1 wherein the digital media is an audio clip and the modified digital media is an audio clip comprising at least one of the plurality of audio product placement material.

8. A computing infrastructure for digital media comprising:
at least one storage configured to store a plurality of processing instructions;
and at least one processor in communication with the at least one storage, and configured to execute instructions to:
identify objects and their corresponding locations in a digital media, employing an automated identification manager, and determine, selectively, appropriate swap replacements among a plurality of product placement material, wherein the identified objects are cataloged and their locations noted, wherein the identified objects are also associated with individual scenes of the digital media;
swap and directly replace, employing an automated replacement manager, directly in specified scenes of the digital media, identified objects with at least one of the appropriate swap replacements using the corresponding locations and output a modified digital media;
distribute the modified digital media, employing a website server.

9. The computing infrastructure of claim 8 wherein the processor is further configured to execute instructions to broadcast the modified digital media based on a schedule, and to additionally distribute modified digital media on demand.

10. The computing infrastructure of claim 8 wherein the digital media is a movie and the modified digital media is a movie comprising at least one of the plurality of product placement material.

11. The computing infrastructure of claim 8 wherein the instruction to identify objects further includes instruction to:
determine scenes in the digital media;
process each scene determined to extract a catalog of identified objects with corresponding locations of those placeholder objects in that scene.

12. The computing infrastructure of claim 8 wherein the instruction to replace at least one of the identified objects further includes instruction to:
compare, for each scene, the catalog of identified objects with the plurality of product placement material, or a subset thereof, and identify the at least one of the appropriate swap replacements; and
swap and directly replace, in each scene, the at least one of the identified objects in that scene with corresponding ones of the at least one of the appropriate swap replacements for that scene identified by the comparing.

13. The computing infrastructure of claim 8 wherein the digital media is a video clip and the modified digital media is a video clip comprising at least one of the plurality of product placement material.

14. The computing infrastructure of claim 8 wherein the digital media is an audio clip and the modified digital media is an audio clip comprising at least one of the plurality of audio product placement material.

15. A computing infrastructure having a plurality of computing nodes, each of the plurality of computing nodes comprising a processor, memory and storage, the computing infrastructure comprising:
at least one storage configured to store a plurality of processing instructions;
and at least one processor in communication with the at least one storage, and configured to execute instructions to:
upload a plurality of product placement material provided by a plurality of product marketing sources;
identify and catalog, using an automated identification manager in an automated mode, identified objects and their corresponding locations in a digital media;
swap and directly replace, in specified scenes of the digital media in an automated mode, using an automated replacement manager, at least one of the identified objects with at least one of the plurality of product placement material, using the corresponding locations and output a modified digital media; and
conduct billing transactions to charge at least one organization for the replacement of the at least one of the identified objects in the digital media;
wherein the automated identification manager and automated replacement manager are collectively part of the computing infrastructure.

16. The computing infrastructure of claim 15 wherein the at least one processor is further configured to execute instructions to:
determine a plurality of scenes in the digital media;
identify and catalog scene specific identified objects for selective replacement in the plurality of scenes; and
promote replacement of the scene specific identified objects.

17. The computing infrastructure of claim 15 wherein the at least one processor is further configured to execute instructions to:
determine automatically, appropriate replacements for the identified objects among a plurality of product marketing material.

18. The computing infrastructure of claim 15 wherein a modified digital media created by replacement of the at least one of the identified objects in the digital media is distributed to a plurality of client devices.

19. The computing infrastructure of claim 15 wherein digital media is uploaded to create the modified digital media by selective replacement of identified objects.

20. The computing infrastructure of claim 15 wherein the instruction to replace at least one of the identified placeholder objects with at least one of the plurality of product placement material further includes instruction to:
scale the at least one of the plurality of product placement material as necessary;
enhance the lighting of the at least one of the plurality of product placement material as necessary; and
swap and directly replace the at least one of the plurality of product placement material as necessary with the at least one of the identified objects in an automated mode.
